(19) United States
(12) Patent Application Publication
(10) Pub. No.: US 2017/0130430 A1
(43) Pub. Date: May 11, 2017

(54) FLUID CONTROL SYSTEMS

(71) Applicant: Sydney SMITH, Yateley (GB)

(72) Inventor: Sydney SMITH, Yateley (GB)

(21) Appl. No.: 15/129,946

(22) PCT Filed: Mar. 30, 2015
(86) PCT No.: PCT/EP2015/056931

§ 371 Date: Sep. 28, 2016

(30) Foreign Application Priority Data
Mar. 28, 2014 (GB) 1405670.9

(51) Int. Cl. E03B 7/07; G01V 9/00; G05D 7/06

(52) U.S. Cl. CPC E03B 7/071; G05D 7/0635; G01V 9/00

(57) ABSTRACT

A water flow control or emergency shut off system for fluid distribution of a dwelling, the fluid system comprises a fluid input and at least one fluid outlet, and the water flow control or emergency shut off comprises an input control means for shutting off or reducing the flow of fluid into the system. It includes a first sensor (20) that detects the presence or proximity of users, and a second sensor (22) that detects the presence or proximity of users, and further at least one input flow sensor, which detects fluid entering the system, and a processing means that receives the signals from the sensors (20, 22), and instructs the input control means to limit the flow of water. The first sensor (20) transmits a first signal, and the second sensor (22) transmits a second signal, and the first and second signals being distinguishable.

This invention relates to fluid control systems, particularly, but not exclusively, for controlling domestic water supplies.

Most buildings in the developed world are supplied with water from a pressurised water distribution network (often called the water mains) maintained by a water authority. Supply pipes connect the water mains to buildings. Typically, once in the building the supply pipe branches to directly supply sanitary fittings, appliances and heating systems with water, or indirectly supplies these fittings, appliances and heating systems via a storage cistern. Where a building is subdivided into flats or offices, the supply pipe may branch into separate supply pipes to each flat or office. There is a large variety of particular configurations, depending on the age of the plumbing, the location, and the nature of the buildings.

Common to all such building water supplies is the problem of water leaks. Accidental damage, corrosion and age, stress due to freezing, or poor installation can cause a pipe or connection in the building to burst or fail, allowing water to be released. Such leaks can cause a great deal of damage and inconvenience. Where leaks occur in a flat or office, flats beneath may also be damaged, and access to stem the leak may be difficult.

There are several known systems that attempt to ameliorate the effect of leaks by shutting off water. One approach is to allow water to flow when an occupant is present in the dwelling, but to shut it off when water is not needed. In these systems, occupancy is often determined using sensors.

There are a number of difficulties with these systems.

There are some appliances, such as washing machines and dishwashers, that require extended periods to finish their operations, and are often purposefully left on when the inhabitant of the dwelling leaves the building.

One system, US2004134545, turns off supply when no occupancy detected, but allows water flow for a sufficient period after last occupancy detected for automatic appliances to finish their cycle. In a similar fashion, GB2452337 allows the user to over-ride the system so that water flow is allowed for a pre-determined time interval (e.g. 1, 2 or 6 hours). It will be seen though that the time required to allow a washing machine or dishwasher to finish its cycle is still considerable, often of the order of half an hour. Allowing a large leak to flow for this amount of time could cause a significant amount of damage before the water is automatically cut off.

FR2661971 shows a detection system which includes an interposition in the line of power supply of the apparatus, so that the system can detect the operation of the devices and allow water flow to the device. US20100258204 detects the operation of the machine by meter use.

Coupling appliances to the water shut off system, or analysing water use to identify appliances are relatively complex and expensive measures.

An aim of the present invention to conveniently permit the operation of automatic appliances such as dishwashers and washing machines.

Where the known systems use sensors to detect the occupancy of the dwelling, generally the sensors detect or check the occupants every few minutes.

The second commonly known approach is to monitor or limit the flow of water into the building or flat. For example, WO2004102049 shows an excess flow shut off valve, where a sleeve in the valve is biased to close the bore, when a pressure difference caused by the flow rate of the water exceeds a particular value. In this way, when a pipe joint breaks loose, the increase in flow rate shuts off the water, and limits the amount of water released. However, not all leaks result in such an increase in flow rate. Smaller leaks will not activate the shut off valve, but may still cause a lot of damage, particular if the leak is not detected. Also, several appliances and fittings may be intentionally used at once, resulting in a high flow rate which activates the shut off valve when there is no leak.

There are further approaches to this problem. For example, DE102009045150 shows a system where sensors associated with various water consuming items detect the presence of a user, for example by use of a proximity sensor, or requiring the user to touch or manually activate the sensor. For some electrical water consuming items such as dishwashers or washing machines, the electrical operation of the item can operate the sensor. Activation of each sensor causes a valve at the building's water inlet to allow water to flow for a predetermined time, based on a predetermined assessed use for the particular item. When a pressure drop at the inlet is detected that is not associated with a user-activated sensor signal, the valve at the water inlet is shut off.

Proximity sensors are often unreliable. Moreover, it is not always convenient to require the presence of a user, or to allocate a predetermined time period to the operation of a water consuming item.

It is an object of the present invention to provide an efficient and convenient method and apparatus to reduce the amount of water released in the event of a leak.

According to the present invention, there is provided an emergency water shut off system as defined by claim 1.

The inventions will now be described by way of example, with reference to the drawings, which show;

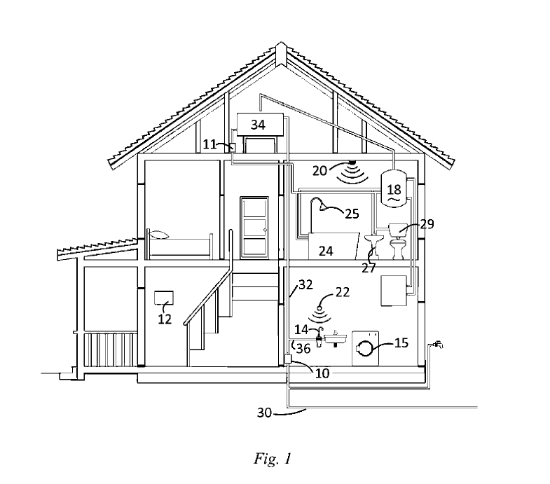

FIG. 1 is a diagrammatic representation of a plumbing system incorporating an embodiment of the invention;

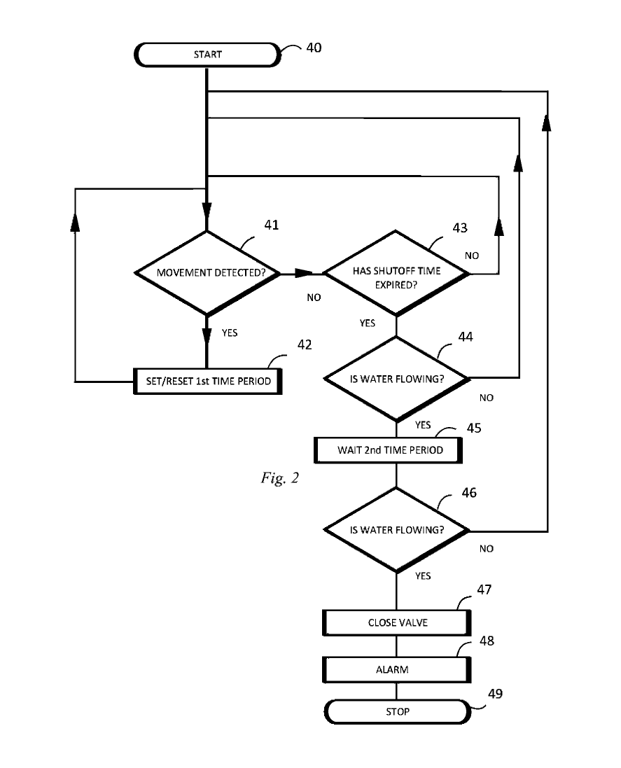

FIG. 2 is a flowchart showing the operation of an embodiment of the invention; and

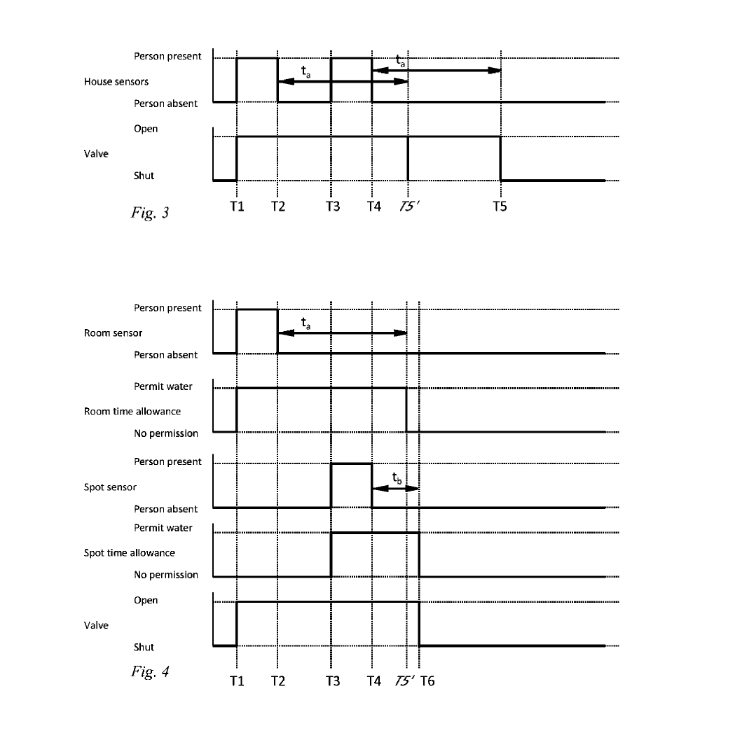

FIG. 3 is a timing diagram of another embodiment of the invention.

FIG. 4 is a timing diagram of another embodiment of the invention.

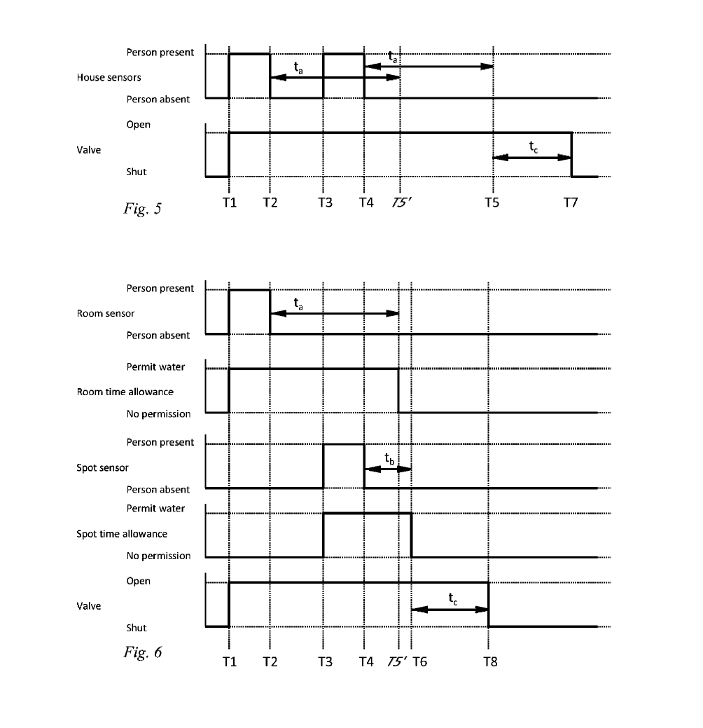

FIG. 5 is a timing diagram of another embodiment of the invention.

FIG. 6 is a timing diagram of another embodiment of the invention.

Referring to FIG. 1, an automatic water shut off system comprises a main shut off valve 10, control panel 12, and a distributed system of sensors 20, 22.

### Configuration

The plumbing system here comprises a main line 30 to a dwelling, which enters the dwelling as a rising main 32, and supplies a loft water storage tank 34, and cold water taps 16 in the kitchen 15. The loft water storage tank 34 then supplies the remaining cold water outlets of the house, such as the cold water input of a mixer tap for a bath 24, a cold water tap of a sink 27, and a toilet 29 in bathroom 25. The loft water storage tank 34 also supplies a boiler or immersion heater 18. The boiler 18 then supplies all the hot water outlets such as hot water input of a mixer tap for the bath 24 and the hot top of the sink 27.

Sometimes a water using device will include an outlet for excess water that feeds back into the system. For example, a boiler expansion pipe may be directed to empty into the loft water storage tank 34.

Most houses also include various white goods that use water and are connected to the house's plumbing system, such as a washing machine 15. Another common appliance that uses water in a similar way, is a dishwashing machine. The washing machine may be fed directly from the rising main, or from the loft water storage tank 34, or even from the boiler 18, or indeed be supplied with both hot and cold water.

A room sensor 20 is included in the bathroom 25. The sensor detects the presence of a person in the bathroom. Many suitable types of sensor are known in the art, such as PIR (passive infra-red), and Doppler-effect movement sensors; such sensors are routinely used for burglar alarms systems. Ideally, the sensor is fitted with long life batteries, and can include an audible and/or visual signal to indicate when the battery is getting low.

In the kitchen 15, a spot sensor 22 is included, near to the taps 14 of the cold water sink. Like the room sensor 20, various types of sensor may be used, but the range of the spot sensor is directed so that the spot sensor is limited to detecting the presence of a person in the vicinity of the cold water sink, rather than anywhere in the kitchen 15. Like the room sensor 20, the spot sensor may be powered by long-life batteries.

Both the room sensor 20 and the spot sensor 22 communicate with a control panel 12; ideally this communication is accomplished using wireless transmission.

At or near the point that the rising main 32 enters the house, the main shut off valve 10 is located inline with the pipework. The shut off valve 10, which may for example be a ball valve, is operated by the control panel 12, such that the control panel can open and shut off the water supply to the plumbing system 15. The communication between the control panel and the shut off valve is ideally wireless. The shut off valve can be powered via a hard-wired connection to mains electric power.

The main shut off valve 10 also includes a time flow meter. The time flow meter senses the flow of water through the rising main at the shut off valve location, and records the time when the flow is on and off. This data is transmitted to the control panel wirelessly.

A secondary shut off valve 11 is located inline with the pipework immediately exiting the loft water storage tank 34. As with the shut off valve 10, the secondary shut off valve is ideally a ball valve, wirelessly operated by the control panel 12, such that the control panel can open and shut off the water supply to the plumbing system 15. The secondary shut off valve operates in the same manner as the main shut off valve; like the main shut off valve, it includes a flow meter, and communicating wirelessly with the control panel. A secondary shut off valve is only required when some type of cold water storage or header tank is used; for directly plumbed systems where all the water is taken directly from the rising main, a secondary shut off valve can be dispensed with.

References in the operation of the system to flow being detected mean when flow is detected either through the main shut off valve or the secondary shut off valve.

### Operation

### (Allowance for Washing Machine/Dishwasher)

Referring to FIG. 2, when the system is activated 40, each sensor continually scans its operating area for signs of occupancy 41. As discussed several types of suitable sensor are already known, for example in use for burglar alarms, automatic lights and doors etc. Typically a sensor will operate at short intervals, for example it will check for movement or other signs of occupancy every 10 second.

When a sensor detects movement, it sends a signal to the control box, which sets a first permitted time period 42, for example three minutes. The sensor continually monitors the area for occupancy 41, and if someone is present, the first permitted time period is continually reset 42, in this case for three minutes in the future, allowing water flow indefinitely while someone is present.

When the occupants leave the monitored areas, monitoring is continued while the permitted time period is extant 43. So for example, if someone enters a bathroom intending to take a bath, their presence is detected and water flow is permitted while they run the bath. If they leave the bathroom briefly, to fetch a clean towel or new bottle of shampoo, the bath will continue to run until the permitted time period has expired 43. If they return within this period, the sensor again detects them, resets the first permitted time period 44 and continues to allow water to flow.

If no occupancy is detected after the expiry of the first permitted time period, the control panel interrogates the flow meter to ascertain if water is flowing 44. If the flow of water has ceased, the system returns to monitoring for occupancy 41 and monitoring for water flow 44.

If water flow is detected 44 at any time after the first permitted time period has elapsed without movement being detected, the system waits for a second time period 45. This second permitted time period is of the order of two minutes. After this time period has elapsed, water flow is re-checked 46; if the flow ceases before the expiry of the second permitted time period, the system returns to monitoring for movement 41 and water flow 44 as previously described. If water flow continues beyond the second time period, the shut off valve activates 47 and optionally an alarm is triggered 48, this forming an end of the system's operation until the system is reset.

The second time period allows washing machines, dishwashers and similar appliances to operate. Such appliances may operate for extended periods, but only require an intake of water for a few short bursts during their period of operation, typically around 45 seconds. Allowing discrete 2 minute flow periods permits their entire operation to proceed without interruption.

Where the sensors detect a period of occupancy followed by absence, water will be permitted to flow for an interval less than or equal to a sum of the first time period and the second time period, in this example 5 minutes, after which water flow will cause the shut off valve to activate and trigger the alarm. This situation may occur when there is a leak, but is more likely to be caused when an occupant forgets that they have left a tap running. Such occurrences can be as damaging to possession and the fabric of the building as a leak caused by a burst pipe.

Where there has been no occupancy detected for some time and the first time period has expired, a flow exceeding the second time period will cause the shut off valve to activate and trigger the alarm. Spontaneous flows of water exceeding two minutes will usually indicate a leak due to a burst pipe or similar.

It will be realised of course that there is a very large variation in plumbing arrangements, particularly as to whether outlets are supplied directly from the rising main, or whether a cold water loft tank is present.

In another embodiment, activation of one the motion sensors wirelessly alerts the control panel, of the presence of a person again initiating a first time period, such as two minutes 55 seconds. If during this time, the bath taps are opened (thus causing a detectable water flow) while the presence of the person is still detected in the vicinity, the control panel extends the time period to twn minutes, allowing the person to leave the room while the bath runs, but without a shut off occuring during this time.

This principle may be used in other rooms and for other water suppies. For example, if the sink motion sensor detects the presence of a person, simultaneously with the operation of the sink, the first time period (e.g. 2 minutes 55 seconds) may again be extended (e.g. to ten minutes). In another variation, the extended period during which water flow is permitted may be contingent on the user being in the kitchen (which may be detected by another sensor).

As new water enters the dwelling, the flow sensor alerts the control panel. When such flow has continued for three minutes, the control sensor checks the status of the time periods generated by the activities of the room or area sensors. As previously described, if the time periods have expired and the above activities are not recorded in the control panel, the water flow is shut off.

### (Multichannel Sensors)

In FIG. 1, there is shown a room sensor 20 for a bathroom 25 and a spot sensor 22 in the kitchen 15 near the taps 14 of the cold water sink. Of course there is a large variation in configuration and layout of water-consuming items in homes, so ideally sensors everywhere that water outlets such as taps, showers, lavatories and the like are situated. Water is typically used in a different manner in different rooms; also, the occupancy of different rooms has a different pattern. For example, it is common to allow water to run for several minutes while running a bath, and leave the room to fetch things. In the kitchen, it is less usual to leave a tap running for unsupervised for very long. Also, the kitchen has long periods of occupancy, often when little water is being used.

Therefore, it advantageous to use different sensors to monitor and allow different types of water use. In this way, the system can more precisely allow water flow to correspond to intended use, while it more quickly prevents prolonged unwanted use or leakage. By installing a spot sensor in the kitchen, which is a comparatively busy room with people entering and leaving, only the presence of a person near to the kitchen taps activates the sensor and so permits water flow. In contrast, in a bathroom, since people almost invariably use water when entering the bathroom, a room sensor can be used to permit water supply.

As already alluded to, a bathroom often experiences different amounts of water use than the kitchen, over different time periods, and with different occupancy patterns. Therefore, it has been found advantageous to identify each sensor separately, monitor each sensor distinctly, and treat their occupancy detections differently.

To illustrate the advantages, a system where simple occupancy is monitored is illustrated, before turning to a system which treats each sensor channel distinctly, to illustrate the advantages.

Referring to FIG. 3, a water shut off system monitors the house for occupancy using several sensors. At T1, a sensor detects the presence of a person in the house—or near a water outlet, if the sensors are set up in that way. The person is detected until T2 (for simplicity, a continuous period of detection is illustrated, although it is to be understood that the sensor may be detecting in discrete short intervals over this time). At T3, occupancy is again detected, until T4 when no-one is detected.

One way to control water flow in such a system is to permit the flow of water for a set period after the last occupancy has been detected, and resetting the period as and when further occupancy is detected. For instance, if the set time period is interval tₐ after T2, then water flow would be allowed up to T5′, had not a second period of occupancy been detected. This second occupancy occurs between T3 and T4; the time period is reset at interval tₐ after T4, which expires at T5. A convenient value for tₐ would be 5 minutes.

Now, turning to FIG. 4, a water shut off system is now configured to look at each sensor individually to monitor the house for occupancy. At T1, a sensor detects the presence of a person in a room such as the bathroom in FIG. 1. The person is detected until T2. At T3, occupancy is again detected—however, it is a spot sensor, such as that found in the kitchen in FIG. 1—which now detects the presence, until T4 when no-one is detected.

As for the system described in FIG. 3, a set time period is interval tₐ is added to T2, which would permit water flow up to T5′ However, for the spot sensor, a shorter time interval time t_{b} is added to the last detection point T4. This expires at a new time T6. A convenient value for t_{b} might be one minute.

It will be seen that T6 of FIG. 4 expires earlier than T5 of FIG. 3 under the same conditions. This is because each signal occupies a distinct channel monitored by the control panel. Since the value t_{b} is relatively short compared to tₐ, it may, as here, expire before tₐ expires, or in any case only extend the total period by its own short value. Different permitted times may be set as appropriate for the type of sensor and the room and outlets it is monitoring. This diminishes the permitted time during which a leak or inadvertent water overflow may be occurring, without interfering with the user in normal operation.

Each sensor then is ideally be paired to the control board, and has a different permitted time associated with it. This permitted time is the first permitted time period described and shown in FIG. 2—when applied to that embodiment, the control board uses the permitted time that would expire last. It will be seen though that this aspect of the invention—the distinct treatment of each sensor or type of sensor—may be applied advantageously to systems where no second permitted time period is included, as shown here.

It will similarly be seen that a water shut off system using the second time period as described in FIG. 2 can be implement to advantage in systems where no distinction is made between the types of sensor, or where only one sensor is included.

The most advantageous system however is where both aspects are incorporated together. Referring to FIG. 5, this shows the system of FIG. 3 where sensors are not distinguished, to which an allowance of time period t_{c} has been added, to permit the operation of automatic appliances. As previously discussed, a time period of 2 minutes would be suitable in most cases. The total time elapsing during which unrestricted flow is allowed, from the last detection of a person T4, is therefore the sum of tₐ and t_{c}, which using our typical figures would be 7 minutes.

Referring to FIG. 6, this shows the system of FIG. 4, again to which an allowance of time period t_{c} has been added, to permit the operation of automatic appliances. The total time elapsing during which unrestricted flow is allowed, from the last detection of a person T4, is now the sum of t_{b} and t_{c}, which using our typical figures would be 3 minutes. So this system both allows the use of automatic appliances, while (depending on which sensors are activated, and the time periods chosen for them) potentially shortening the time where unrestricted flow is allowed after the last detection of a person.

The control panel may include emergency buttons that operate independently to the systems described above, simply by shutting off the water supply by pressing the emergency button. If there is an unexplained leak (possibly coinciding with a flautly sensor), the water supply may be easily shut off without the owner having to locate a stop cock. Further the emergency button could be resettable from the control panel, for example if it transpires that such a leak was not due to the water supply.

1. A water flow control or emergency shut off system for fluid distribution of a dwelling the fluid system comprising a fluid input and at least one fluid outlet, the water flow control or emergency shut off comprising an input control means for shutting off or reducing the flow of fluid into the system, a first sensor that detects the presence or proximity of users a second sensor that detects the presence or proximity of users at least one input flow sensor detects fluid entering the system, a processing means that receives the signals from the sensors, and instructs the input control means to limit the flow of water wherein the first sensor transmits a first signal, and the second sensor transmits a second signal, the first and second signals being distinguishable.

2. A system according to claim 1, wherein the processing means calculates a first time interval from the first signal, and a second time interval from the second time signal, and instructs the input control means when the first time interval and second time interval have both expired.

3. A system according to claim 2, wherein the first time interval is different to the second time interval.

4. A system according to claim 3, wherein the processing means additionally allows water to flow for one or more discrete time intervals of between 30 seconds and 10 minutes.

5. A system according to claim 4, wherein the time intervals are less than three minutes.

6. A water flow control or emergency shut off system for fluid distribution of a dwelling the fluid system comprising a fluid input and at least one fluid outlet, the water flow control or emergency shut off comprising an input control means for shutting off or reducing the flow of fluid into the system, one or more sensors that detect the presence or proximity of users at least one input flow sensor detects fluid entering the system, a processing means capable of determining whether the dwelling or part of the dwelling is in an unoccupied state, and limiting the flow of water during this unoccupied state wherein the processing additional allows water to flow for one or more discrete time intervals of between 30 seconds and 10 minutes.

7. A system according to claim 6, wherein the time intervals are less than three minutes.

8. A water flow control or emergency shut off system for fluid distribution of a dwelling the fluid system comprising a fluid input and at least one fluid outlet, the water flow control or emergency shut off comprising at least one input control means for shutting off or reducing the flow of fluid into the system, one or more sensors that detect the presence or proximity of users at least one input flow sensor detects fluid entering the system, wherein the fluid distribution includes a storage cistern, and an input control means is located leading from the storage cistern.
